(19) United States
(12) Patent Application Publication
(10) Pub. No.: US 2017/0052514 A1
(43) Pub. Date: Feb. 23, 2017

(54) METHOD AND COMPUTER SOFTWARE PROGRAM FOR A SMART HOME SYSTEM

(71) Applicant: THUY VAN T. DUONG, Ho Chi Minh City (VN)

(72) Inventor: THUY VAN T. DUONG, Ho Chi Minh City (VN)

(73) Assignee: TON DUC THANG UNIVERSITY, Ho Chi Minh (VN)

(21) Appl. No.: 14/828,475

(22) Filed: Aug. 17, 2015

(51) Int. Cl. G05B 13/02

(52) U.S. Cl. CPC G05B 13/0265

(57) ABSTRACT

A method and a computer software program for operating a smart home system including a sensor electrically coupled to each device, a central processing unit (CPU), and a data storage is disclosed that includes the steps of receiving attributes of a user, calculating a distance between the user and a device, performing a distance analysis, forming a habitual usage profile using a sequence pattern data mining algorithm, and sending a habitual usage command in accordance with said habitual usage profile.

### FIELD OF THE INVENTION

The present invention relates generally to the field of electronic devices. More specifically, the present invention relates to a smart home system.

### BACKGROUND ART

Since the beginning of the twentieth energy, energy saving has been critical for sustainable development because of the explosive population growth. The majority of energy consumption is from home or office uses. The government policy including charging penalties for excessive energy usage does not solve the problem due to continuing population growth. Therefore, building smart homes has become the trend for both convenient living and energy saving.

The current prior-art smart home systems are based on scheduling schemes. In the scheduling schemes, the prior-art smart home systems are programmed by users to provide a fixed schedule for turning on or off some devices in the house. For example, the current prior-art smart home systems are programmed to turn on the lights, a backyard watering system, or air conditioners, etc. at a specified time of the day.

However, the current prior-art smart home systems are too rigid to adapt to users' change in behaviors or work schedules. In other words, the prior-art smart home systems do not based on user's habit at all, they are based on a fixed schedule provided by users. Thus, the current prior art smart home systems lack the capability of learning and relearning new habits. This results in inconveniences for users, continuing energy waste. More particularly, devices are continued to be turned on according to the old schedule even when the users do not want to use them or when users are not even home due to unexpected events. Furthermore, the current prior-art smart home systems do not provide automatic operations for all devices in the house; only a few selected devices can be programmed by the current prior-art smart homes. Yet, in the current prior-art smart home systems, old devices must be replaced in order to be programmed. Thus, the current prior-art smart home systems are costly and do not provide flexibility, energy saving, and quality of life for users.

Therefore what is needed is a smart home system that is capable of adapting to each user's habit and relearning new habits.

### SUMMARY OF THE INVENTION

Accordingly, an objective of the present invention is to provide a smart house that provides solutions to the problems described above. Thus, A method and a computer software program for operating a smart home system including a sensor electrically coupled to each device, a central processing unit (CPU), and a data storage is disclosed that includes the steps of receiving attributes of a user, calculating a distance between the user and a device, performing a distance analysis, forming a habitual usage profile using a sequence pattern data mining algorithm, and sending a habitual usage command in accordance with said habitual usage profile.

These advantages of the smart home of the present invention over the prior-art smart home systems can be listed in detail as followings:

Low costs.

Capability of operating each device in the house based on habit formed from data mining algorithm.

Capability of relearning and updating each user's newly formed habit.

Capability of using old devices without the need to buying new devices designed to be programmed by prior-art smart homes.

Capability of operating with all devices in the house.

These and other advantages of the present invention will no doubt become obvious to those of ordinary skill in the art after having read the following detailed description of the preferred embodiments, which are illustrated in the various drawing Figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a diagram illustrating a smart home system having a sensor connected to control each device and a habit learning unit in accordance with an embodiment of the present invention;

FIG. 2 is a system level schematic diagram illustrating a CPU, a central switching unit (CSU), and the sensors operating together to create the smart house system in accordance with an embodiment of the present invention;

FIG. 3 is a system level diagram illustrating the operation of the smart home system in accordance with an embodiment of the present invention;

FIG. 4 is a flow chart illustrating a method for providing a smart home system based on users' habits in accordance with an embodiment of the present invention;

FIG. 5. is a flow chart illustrating a method and a computer software program for learning a habit of a user in accordance with an embodiment of the present invention;

FIG. 6 is a flow chart illustrating a method and a computer software program for updating a user's new habit in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

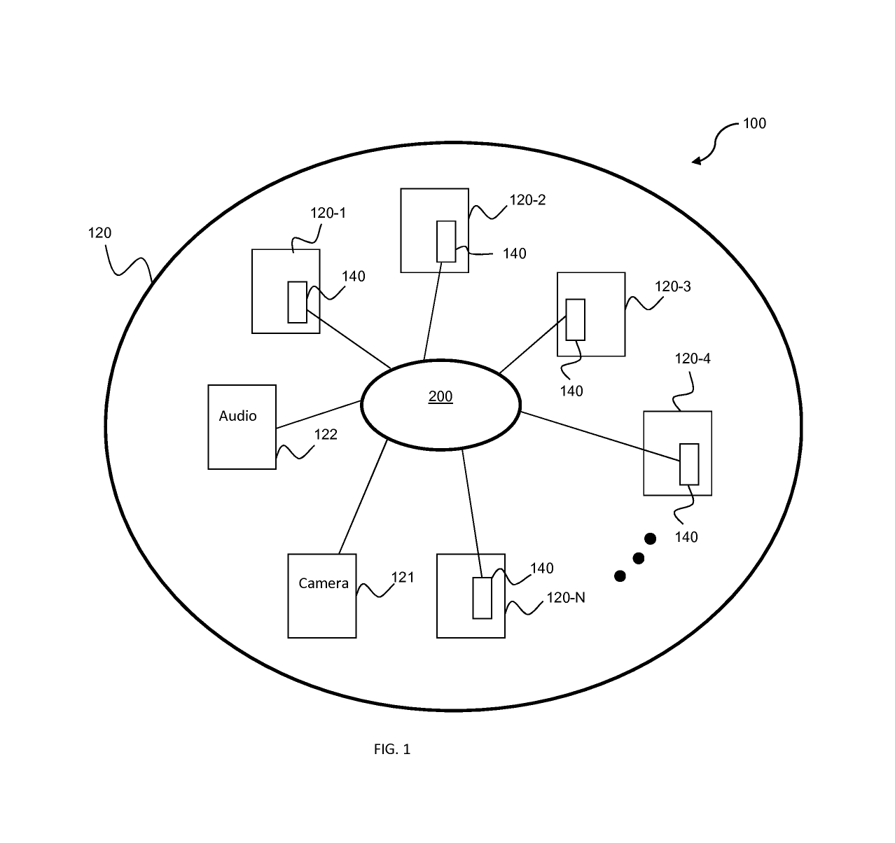

Referring now to FIG. 1 which illustrates a smart home 100 including devices 120-1 to 120-N and a smart home system 200. Each device, 120-1 to 120-N, is equipped with a sensor 140. Smart home system 200 is provided for a house 120. In the present invention, smart home system 200 is configured to operate each device 120-1 to 120-N according to each user's habit. In one example, devices 120-1 to 120-N includes, but is not limited to, a washing/drying machine 120-1, an air conditioner 120-2, a flat screen 120-3, a microwave oven 120-4, a refrigerator 120-5, a computer 120-6, and a desk lamp 120-7, etc. Sensor 140 is coupled to control each of the above-listed devices 120-1 to 120-N. A central camera system 121 and a microphone system 122 are also installed in smart home 100 of the present invention.

In on embodiment of the present invention, all electrically controlled water outlets, i.e., 120-7, such as touched faucets and timed sprinklers are also equipped with sensor 140. Smart home system 200 communicates to each sensor 140 to provide adaptive habitual usage profile for user and for each device 120-1 to 120-N. A habitual usage profile is a set of data reflecting a pattern of device usage over time of a particular user.

Continuing with FIG. 1, in operation, smart home system 200 observes and learns habitual usage profile of each user on each device. Then all devices 120-1 to 120-N are automatically turned on or off according to such habitual usage profile. For example, if a user A has the habit of studying at 7 p.m. every day during the week after dinner. Smart home system 200, after observing such habit of user A over a set period of time, automatically turns on desk lamp 120-6 and computer 120-5 for user A when he or she approaches those devices. If sensor 140 senses user A approaching at 7 p.m., sensor 140 sets device 120-5 and 120-6 to ready mode. In the ready mode, sensor 140 lets smart home system 200 takes control over devices 120-5 and 120-6 according to habitual usage profile of user A.

In another situation, for some reasons, if user A does not want to study and is not in the room at 7 p.m., sensor 140 is not connected to user A, sensor 140 thus takes control over smart home system 200 and keep those devices in the off states. In another exceptional situation, when user A comes home late and has dinner late. User A enters the study room 30 minutes late to study. Sensor 140 senses user A approaching and connected to devices 120-5 and 120-6, setting them to ready mode. In this situation, because smart home system 200 does not register this situation in the habitual usage profile, it lets user A turn on those devices by his or herself.

Continuing with FIG. 1, yet in another situation where user A has a habit of studying for 3 hours which is recorded in his or her habitual usage profile. Knowing this habitual usage profile, smart home system 200 automatically maintains those devices as long as user is still there. When user A leaves the room after 3 hours, devices 120-5 and 120-6 are set to a standby or sleep mode. Recognizing the stand-by mode, Smart home system 200 turns off devices 120-5 and 120-6 according to habitual usage profile of user A. However, in one exceptional case, user A leaves the room early because she or he does not have much homework that day, devices 120-5 and 120-6 are then set to stand-by mode and turned off before the specified hour (e.g., 11 p.m.) by sensor 140. Thus, energy is saved because of the smart home system 200.

Continuing again with FIG. 1, smart home system 200 is capable of relearning and updating a user's habitual usage profile in accordance with an embodiment of the present invention. In the above example, if user A continually does not enter the room to study, smart home system 200 learns new behavior and updates user A's habitual usage profile. Accordingly, computer 120-5 and desk lamp 120-6 are not turned on by smart home system 200 at the specified 7 p.m. Instead other device such as a game console, i.e., 120-8, is turned on at 7 p.m. in accordance with the new habitual usage profile of user A.

Please note that the above example is only an illustration of the habitual usage profile of user A on computer 120-5 and desk lamp 120-6. The above example does not limit the scope and capability of the present invention. Smart home system 200 of the present invention is capable to applying to every device in house 120 including sprinkler and water faucets for every user in house 120. Any device which can be controlled by sensor 140—whose structure and operation will be described later, is within the scope of the present invention.

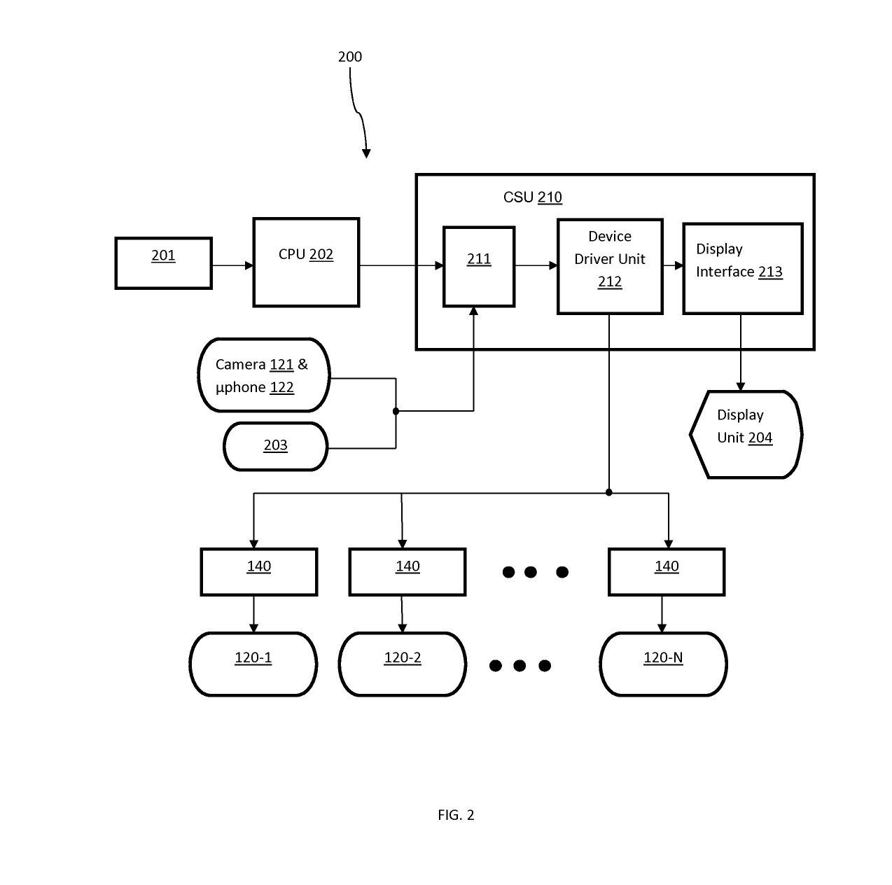

Next, referring to FIG. 2 which illustrates a system level schematic diagram of smart home system 200 in accordance with an embodiment of the present invention. Smart home system 200 includes a behavior pattern data server 201, a central processing unit 202, a central switching unit (CSU) 210, a display 204, central camera system 121, and an voice IP unit 203, all electrically connected together as shown in FIG. 2. Behavior pattern data server 201 is a database which stores all the time series device usage history of a user. Attributes of a user such as voice, image, RF identification are also stored in behavior pattern data server 201. In one embodiment, infrared profile of a user is also stored in behavior pattern data server 201. These attributes are assigned to each user's device usage history to determine the habitual usage profile. In other words, all device usage history and attributes of a user is stored in behavior pattern data server 201.

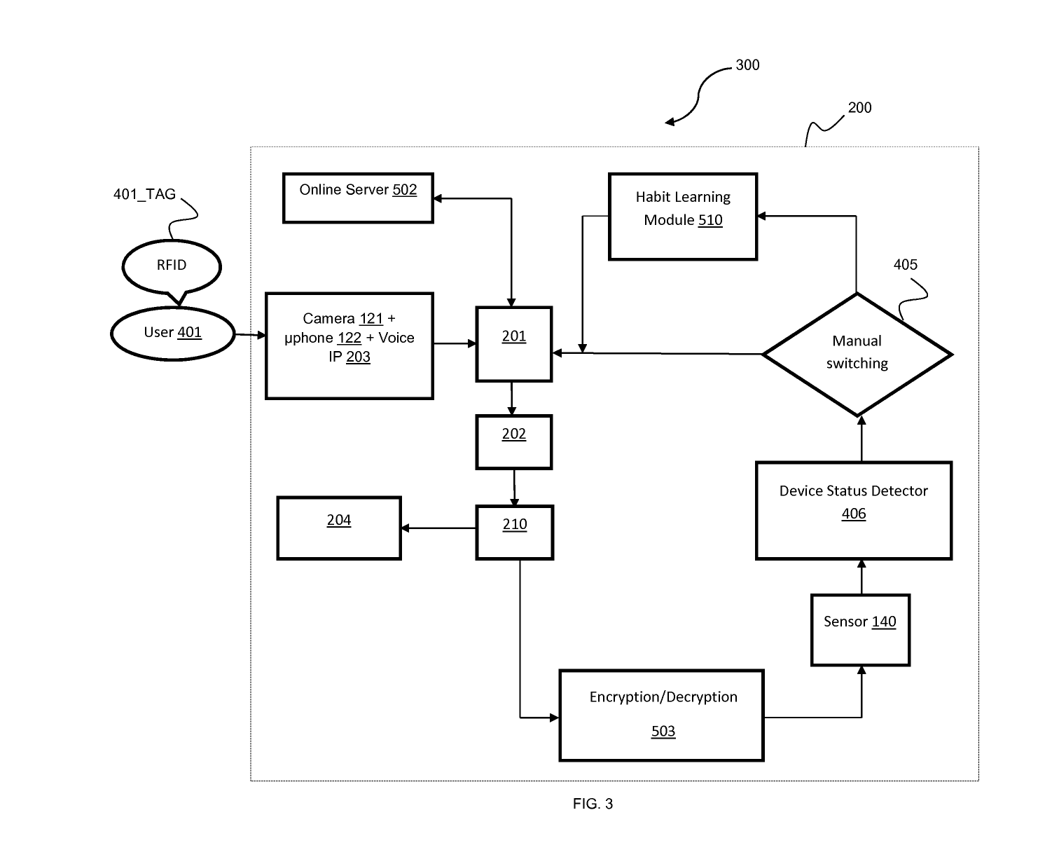

Continuing with the description of FIG. 2, CPU 202 is the brain of smart home system 200 of the present invention. The detail description of CPU is described later in the following FIG. 3-FIG. 6. CPU 202 learns the behavioral usage profile of each user and issues habitual operation commands to central switching unit 210. Upon receiving habitual operation commands, CSU 210 decodes these commands and switch these commands to appropriate devices 120-1 to 120-N according to each user's habitual usage profile. Next, based upon each device status set by sensor 140, CSU 210 turns on or turns off each device, 120-1 to 120-N, in accordance with habitual operation command from CPU 202. CSU 210 also includes a display interface 213 coupled to display system 204 to display the status of use for each device in house 120.

Next, referring to FIG. 3, a system level structure 300 of behavior pattern data server 201 in communication with CPU 202 is illustrated. Behavioral pattern data server 201 includes a data management unit 301, a search engine 302 and a memory 303. In one embodiment, memory 303 is flash memory. Data management unit 301 manages all data including user's attributes and device usage history. Data management unit 301 functions to organize and associate which device 120-1 to 120-N is used by which user. Data management unit 301 also maintains these data records in chronological order. Search engine 302 receives a search string from CPU 202. Search engine 302 looks into behavior data storage 303 to retrieve specific information for CPU 202.

Continuing with FIG. 3, CPU 202 includes sensors managing unit 321, image managing unit 322, RFID managing unit 323. CPU 202 then feeds these data into a decision making unit 324. In one embodiment, decision making unit 324 also includes a habit forming module which will be discussed in details later. As shown in FIG. 3, sensors managing unit 321 receives current usage information from devices 120-1 to 120-N and sensors 140. Similarly, image managing unit 322 receives and manages image pictures from each user in each room of house 120. RFID managing unit 323 receives and manages identification signals from each user. All of the information are fed into decision making unit 324 to learn the habit of a user and to formulate a behavior usage profile therein. Past usage history and attributes from each user are retrieved by CPU 202 from behavior pattern data server 201 via communication channel 310. CPU 202 and particularly decision making unit 324 combine past and present data usage for each user to formulate habit and/or update habit.

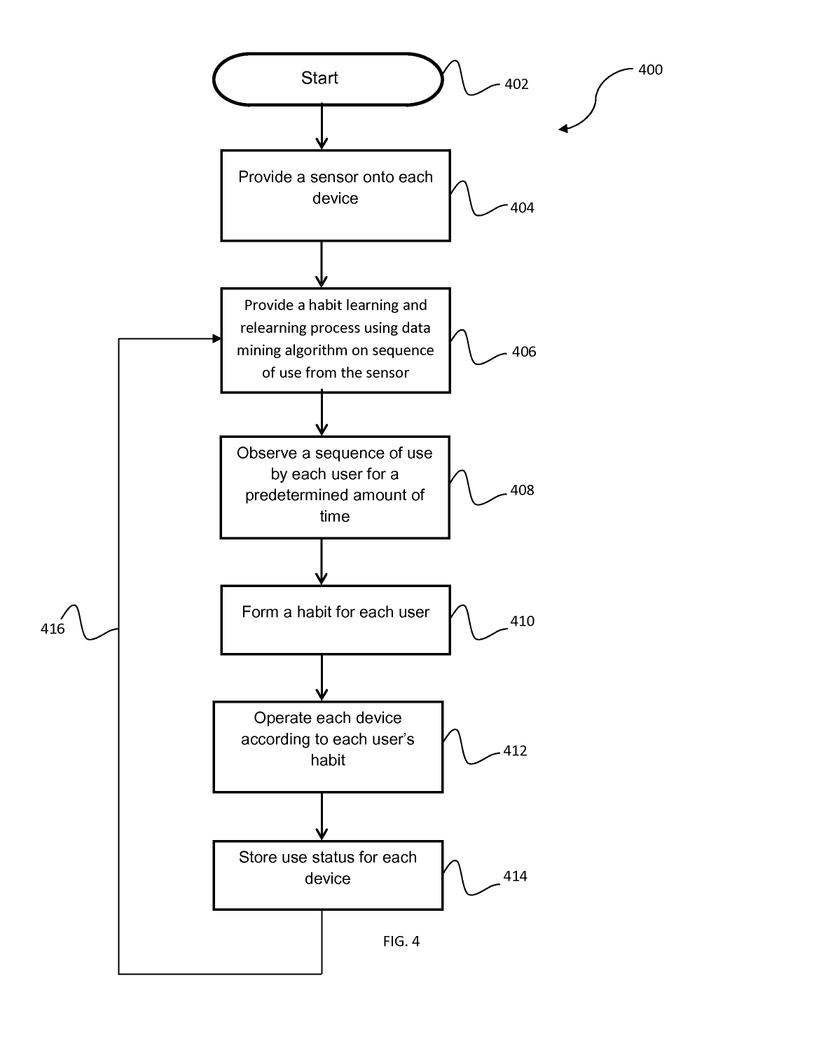

Now referring to FIG. 4, a method 400 for provide a smart home system 200 as described above is illustrated. Basically, method 400 provides sensor 140 to each device 120-1 to 120-N in smart home system 200. Then a data mining algorithm using a sequence of usage S₀ and S₁ is provided to learn and continually update habitual usage profile for each user 401.

At step 402, smart home system 200 in accordance with the present invention is started. Please note that smart home system 200 has the capability to use with all current devices 120-1 to 120-N without the need to purchase new devices. Step 402 is realized by collecting all the parts specified above for smart home system 200.

Then at step 404, a sensor is coupled to each device 120-1 to 120-N. Step 604 is realized by sensor 140 described in details above.

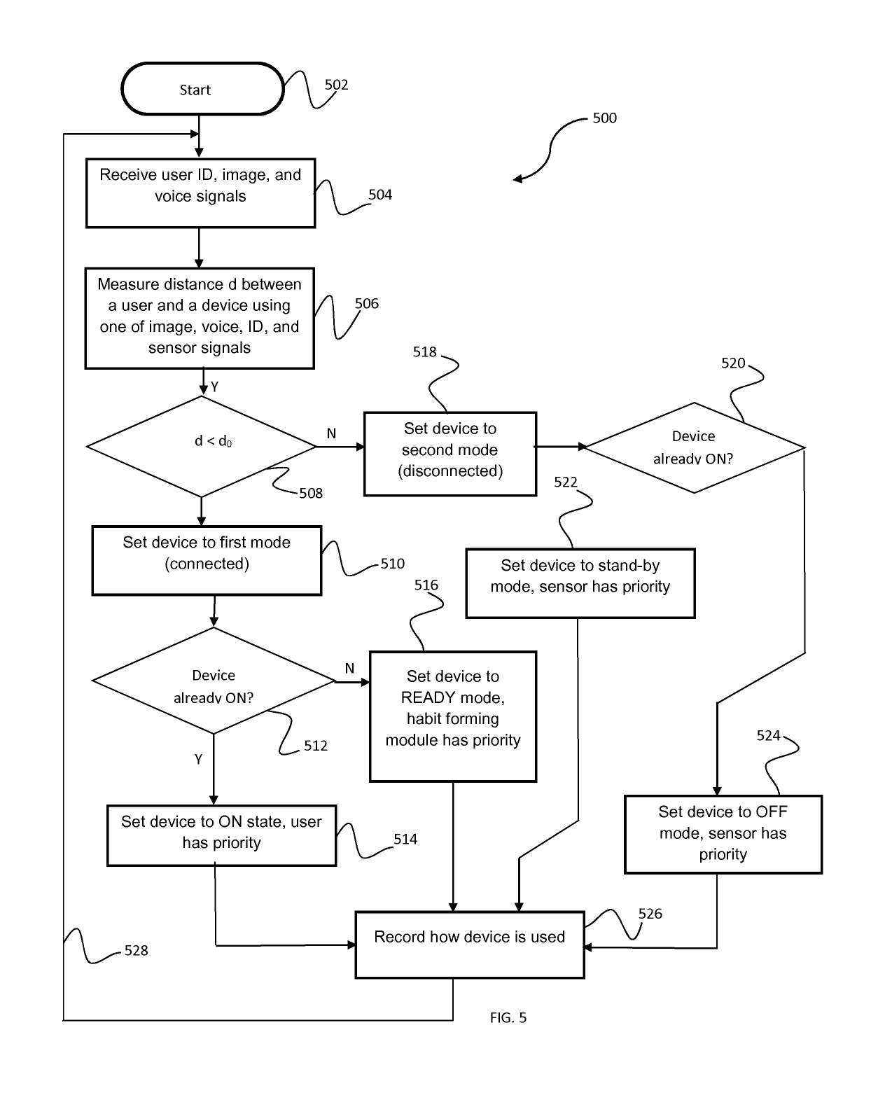

At step 406, a habit learning and relearning process using data mining algorithm performed on sequence of use by a user is provided. Step 606 is realized by CPU 202 in connection with central switching unit (CSU) 210, device status detector 406, habit forming module 510, and sensor 140 as described in FIG. 5 above.

At step 408, a sequence of device usage by each user is observed for a predetermined amount of time is provided. Step 408 is realized by behavioral pattern data server 201. In one embodiment, the predetermined time for observing a user's device usage is set to be 3 months.

Next, at step 410, a habit for each user is formed base on step 408 to establish a behavioral usage profile for each user. Step 410 is realized by data mining techniques on sequences S₀ and S₁ described in FIG. 5 above.

At step 412, each device, 120-1 to 120-N is operated based on habitual usage profile established in step 410 above. In practice, step 412 is realized by habitual operation commands issued by CPU 202 to central switching unit (CSU) 210.

Following is step 414, each time a user uses a device, such usage is recorded to establish new habitual usage profile. In other words, to learn a new habit from each user. Step 414 is realized by behavior pattern data server 201 described above.

Finally, steps 416 and 414 are repeated by means of step 416 in order to establish a habit for a user. Step 416 is realized and performed by smart home system 200 described above.

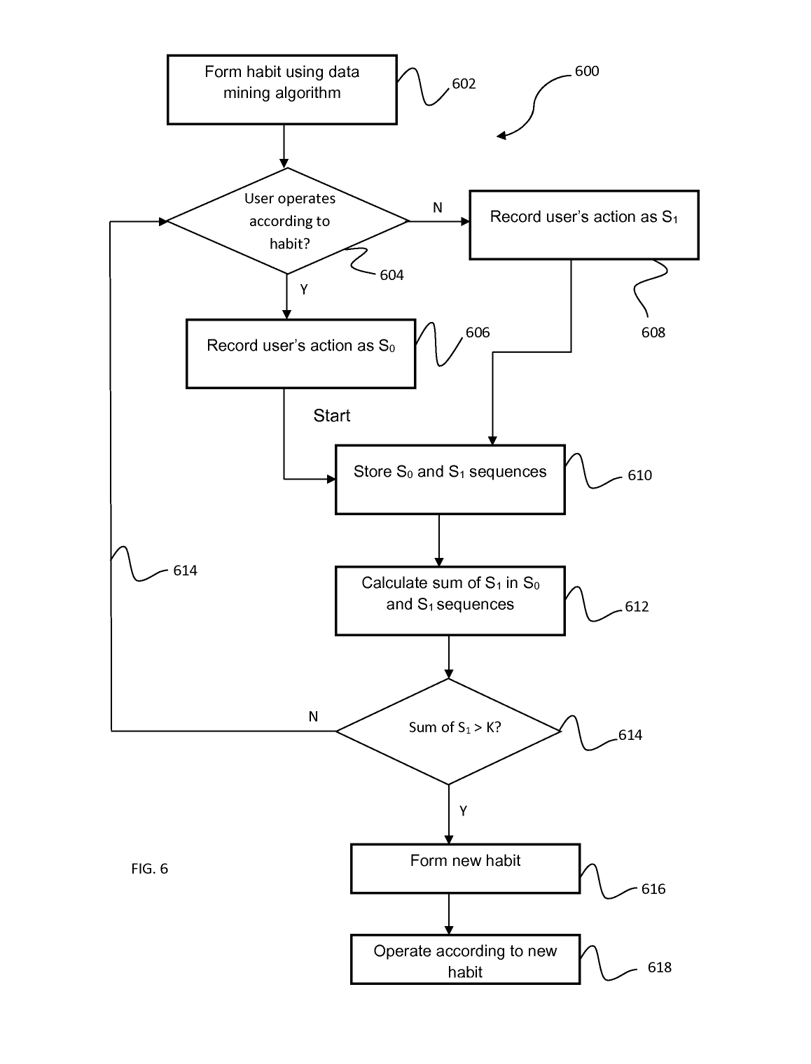

Referring now to FIG. 5 which illustrates a flowchart 500 of a method and a computer software program for operating smart home system 200 described above in FIG. 1-FIG. 3 in accordance with an embodiment of the present invention. From FIG. 5 to FIG. 6, for discussion purpose, a particular device used by user 401 is denoted as 120-m, where 1≦m≦N.

At step 502, smart home system 200 in accordance with the present invention is started. Step 502 is realized by connecting all the hardware described above in FIG. 1-FIG. 3 for smart home system 200. Step 502 also includes installing the computer software program stored in a computer readable storage medium in CPU 202. Computer readable storage medium stored in CPU 202 includes non-transitory memory such as flash memory, read only memory (ROM), or random access memory (RAM).

At step 504, attributes of user 401 are received and managed. 140. More particularly, attributes includes RFID 401_TAG, image signals, audio signals from user 401. Step 504 also provides filtering, decoding, and mapping these signals to a particular user 401 since each user has different voice, image, and RFID 401_TAG. In one embodiment, step 504 also includes receiving voice IP of user 401, translates them into computer coded commands that are understood by device 120-m.

Next at step 406, distance d between user 401 and device 120-m is calculated using attributes obtained from step 404. In one embodiment, sensor 140 uses Bluetooth signals under IEEE 802.15 standard. In situation where Bluetooth signals are not available, step 406 also uses image signals and voice commands from user 401 to measure distance d.

Following step 506, after distanced is obtained, at step 508, distance d is compared with a threshold distance d₀.

At step 510, if distance d is less than or equals to the threshold distance d₀, d≦d₀, device 120-m is set to a first mode. In one embodiment, the first mode is a connected mode. That is user 401 is close enough with one of devices 120-1 to 120-N so that device 120-m is said to be connected to user 401.

At step 512, a state of use of one of the device 120-1 to 120-N is determined. The state of use of device 120-m is either ON or OFF at the moment user 401 is at distance d≦d₀.

At step 514, if device 120-m is ON, device 120-m is determined to be in an ON mode. In this mode, user 401 has priority over sensor 140 or habit forming module 510. That is, device 120-m waits for user 401 to take action either turning off or leaves the device 120-m on. It is said that habit forming module 510 and habitual usage command are overridden by user 401.

At step 516, if device 120-m is OFF, device 120-m is determined to be in a READY mode. In the READY mode, habit forming module 510 and habitual usage commands have priority. At a specified time (i.e., at 7 p.m., please refer to the discussion of FIG. 1 above), habit forming module 510 automatically turns on device 120-m according to habitual usage profile of user 401.

At step 518, on the other hand, if distance d is greater than the threshold distance d₀, d>d₀, device 120-m is set to a second mode different from the first mode. In one embodiment, the second mode is a disconnected mode. That is user 401 is far away from device 120-m so that device 120-m is said to be disconnected to user 401.

At step 520, a state of use of one of the device 120-m is again determined. The state of use of device 120-m is either ON or OFF at the moment user 401 is at distance d>d₀.

At step 522, if device 120-m is ON, device 120-m is determined to be in a stand-by mode. In this mode, sensor 140 has priority over habit forming module 510. If user 401 does not come back, sensor 140 puts device 120-m to sleep mode or turn it off. In one embodiment, if there exists a conflict between habitual usage commands and sensor 140, sensor 140 overrides habit usage commands and put device 120-m in a sleep mode. Otherwise, if there is no conflict, sensor 140 simply turns off device 120-m.

Finally, at step 524, if device 120-m is OFF, it is determined to be in an OFF mode. In this mode, sensor 140 again has priority over habit forming module 510.

At step 526, the results of how device 120-m are operated from steps 510-524 above is recorded.

Finally, at step 528, repeat step 504 to 526 for a predetermined amount of time until the habitual usage profile is formed.

Next, referring to FIG. 6, a flow chart 600 of a method for updating a new habit is illustrated.

At step 602, habit is learned and habitual usage profile is built from observing habit of user 401. In one embodiment, steps 502 to 528 described in FIG. 5 are used. It is noted that step 602 is not limited to steps 502-528 above.

At step 604, whether a user operates device 120-m according to habitual usage profile is determined.

At step 606, if user 401 follows the habitual usage profile, a S₀ is recorded. In one embodiment, S₀ is a binary code 0. In another embodiment, S₀ is any computer coded signal such that CPU 202 understands that its habitual usage command is followed.

At step 608, if user 401 does not follow his or her habitual usage profile, a S₁ is recorded. In one embodiment, S₁ is a binary code 1. In another embodiment, S₁ is any computer coded signal such that CPU 202 understands that its habitual usage command is not followed. In other words, S₁ represents a situation where habitual usage command is overridden.

At step 610, sequence of S₀ and S₁ is stored over time. In one embodiment, S₀ and S₁ also contain additional information such as time of day, location, and user.

At step 612 the sum of S₁ is calculated among two sequences S₀ and S₁. In other words,

$${\sum }_{i} {S}_{1 ij}$$

where i represents a usage occasion and j represents user 401. In one embodiment, ΣS_{1,i j} also includes k represents a device among devices 120-1 to 120-N.

Continuing with FIG. 6, at step 614 whether

$${\sum }_{i} {S}_{1 ij} > K ,$$

where K is a preset constant. In one embodiment, constant K can be reprogrammed into habit forming module 510 and/or CPU 202.

At step 616, when

$${\sum }_{i} {S}_{1 ij} > K ,$$

then habit forming module 510 recognizes such action as a new habit. As a consequent, the habitual usage profile is reset. Then, CPU 202 issues a new habitual operation command series to central switching unit (CSU) 210 for that particular user j.

At step 618, device 120-m is operated according to new habitual usage profile.

Finally, At step 620, on the other hand, if

$${\sum }_{i} {S}_{1 ij} < K ,$$

then habit forming module 510 maintains the same habitual usage profile for user j.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A computer software program stored in a non-transitory computer readable medium for operating a smart home system which comprises a sensor electrically coupled to each device, a central processing unit (CPU), and a data storage, said computer program comprising:
receiving attributes of a user, said attributes comprising user identification, user image information and user's voice signal information;
calculating a distance between said user and a device using said attributes of said user;
performing a distance analysis by comparing said distance with a threshold distance, wherein if said distance is greater or equal to said threshold distance, set said device to a first state and said distance is less than said threshold distance, set said device to a second state different from said first state;
operating said device in accordance with said first state and said second state; and
storing data of device operation history;
forming a habitual usage profile using a sequence pattern data mining algorithm; and
sending a habitual usage command in accordance with said habitual usage profile.

2. The computer software program of claim 1 further comprising setting said device in a ready state to be controlled by said habit forming module when said device is turned off and set in said first mode; and
setting said device in an ON state to be controlled by said user wherein said device is turned on and set in said first mode.

3. The computer software program of claim 1 further comprising setting said device in a stand-by mode to be controlled by said sensor when said device is turned on and set in said second mode; and
setting said device in an OFF state to be controlled by said sensor wherein said device is already turned off and set in said second mode.

4. The computer software program of claim 3 further wherein in said second mode said habitual operation commands from said central processing unit are overridden.

5. The computer software program of claim 1 wherein said forming a habitual usage profile using a sequence pattern data mining algorithm further comprises recording a sequence of signals S₀ or S₁, wherein S₀ represents a sequence of actions where said operation command signal is performed according to said habitual usage profile for each user and S₁ represents a sequence of actions by a particular user where said habitual operation commands are overridden.

6. The computer software program of claim 5 wherein said sequence S₀ and S₁ further comprise number of usage per day, location of usage, and time of usage.

7. The computer software program of claim 5 wherein said forming a habitual usage profile using a sequence pattern data mining algorithm further comprises counting and comparing said sequence S₁ with a preset constant K, if
$${\sum }_{i} {S}_{1 ij} > K ,$$
where j is an integer representing a user in the house and i is an integer representing each time a user j uses an device, updating habitual usage profile as new habit and issuing a new habitual operation command for that particular user j.

8. The computer software program of claim 5 wherein said forming a habitual usage profile using a sequence pattern data mining algorithm further comprises if
$${\sum }_{i} {S}_{1 ij} < K ,$$
then maintaining said habitual usage profile for said user j.

9. The computer software program of claim 1 wherein said step of calculating a distance between said user and a device using said attributes of said user comprising using Bluetooth technology.

10. The computer software program of claim 1 further comprising using a voice iP module to transform a vocal command from said user into computer coded commands to turn on or turn off said device.

11. A method for providing a smart home system which comprises a sensor electrically coupled to each device, a central processing unit (CPU), and a data storage, said computer program comprising:
receiving attributes of a user, said attributes comprising user identification, user image information and user's voice signal information;
calculating a distance between said user and a device using said attributes of said user;
performing a distance analysis by comparing said distance with a threshold distance, wherein if said distance is greater or equal to said threshold distance, set said device to a first state and said distance is less than said threshold distance, set said device to a second state different from said first state;
operating said device in accordance with said first state and said second state; and
storing data of device operation history;
forming a habitual usage profile using a sequence pattern data mining algorithm; and
sending a habitual usage command in accordance with said habitual usage profile.

12. The method of claim 1 further comprising setting said device in a ready state to be controlled by said habit forming module when said device is turned off and set in said first mode; and
setting said device in an ON state to be controlled by said user wherein said device is turned on and set in said first mode.

13. The method of claim 1 further comprising setting said device in a stand-by mode to be controlled by said sensor when said device is turned on and set in said second mode; and
setting said device in an OFF state to be controlled by said sensor wherein said device is already turned off and set in said second mode.

14. The method of claim 3 further wherein in said second mode said habitual operation commands from said central processing unit are overridden.

15. The method of claim 1 wherein said forming a habitual usage profile using a sequence pattern data mining algorithm further comprises recording a sequence of signals S₀ or S₁, wherein S₀ represents a sequence of actions where said operation command signal is performed according to said habitual usage profile for each user and S₁ represents a sequence of actions by a particular user where said habitual operation commands are overridden.

16. The method of claim 5 wherein said sequence S₀ and S₁ further comprise number of usage per day, location of usage, and time of usage.

17. The method of claim 5 wherein said forming a habitual usage profile using a sequence pattern data mining algorithm further comprises counting and comparing said sequence S₁ with a preset constant K, if
$${\sum }_{i} {S}_{1 ij} > K ,$$
where j is an integer representing a user in the house and i is an integer representing each time a user j uses an device, updating habitual usage profile as new habit and issuing a new habitual operation command for that particular user j.

18. The method of claim 5 wherein said forming a habitual usage profile using a sequence pattern data mining algorithm further comprises if
$${\sum }_{i} {S}_{1 ij} < K ,$$
then maintaining said habitual usage profile for said user j.

19. The method of claim 1 wherein said step of calculating a distance between said user and a device using said attributes of said user comprising using Bluetooth technology.

20. The method of claim 1 further comprising using a voice IP module to transform a vocal command from said user into computer coded commands to turn on or turn off said device
